(19) United States
(12) Patent Application Publication
(10) Pub. No.: US 2013/0096732 A1
(43) Pub. Date: Apr. 18, 2013

(54) METHOD FOR ASSISTING A PARKING MANEUVER

(71) Applicants: Lorenz Hagenme, Ostfildern (DE); Michael Schmitt, Gerlingen (DE)

(72) Inventors: Lorenz Hagenme, Ostfildern (DE); Michael Schmitt, Gerlingen (DE)

(21) Appl. No.: 13/581,138

(22) PCT Filed: Feb. 8, 2011
(86) PCT No.: PCT/EP2011/051779

§ 371 Date: Dec. 31, 2012

(30) Foreign Application Priority Data
Feb. 26, 2010 (DE) 10 2010 002 409.0

(51) Int. Cl. G06F 17/00; G08G 1/0962

(52) U.S. Cl. CPC G06F 17/00; G08G 1/0962
USPC 701/1

(57) ABSTRACT

A driving assistance device having a control unit including a memory unit for storing sensor signals, in particular while parking into a parking space, in which the driver is provided with optimization tips on a computer, which is separate from the control unit, during a later evaluation.

### FIELD OF THE INVENTION

The present invention is directed to a method for ascertaining and evaluating a parking space as well as a computer program and a computer program product for carrying out this method.

### BACKGROUND INFORMATION

To assist a parking maneuver, various driver assistance systems are used, e.g., ParkPilots, which calculate a trajectory for a parking maneuver and provide the driver with appropriate driving instructions to carry out the parking maneuver. The driver assistance systems of this type use, for example, parking space measuring (PSM) systems which, for example, ascertain the length and the relative position of a parking space in relation to one's own vehicle with the aid of ultrasound sensors or radar sensors and evaluate a possible parking maneuver as a function of the length of one's own vehicle and, if necessary, of the required trajectory.

A method for ascertaining a parking space is described in European Patent Application No. EP 1 685 002 A1. The method steps carried out for this purpose during the parking maneuver are: measuring a parking space and outputting a measured length of the parking space, comparing the ascertained length to at least one limiting value and ascertaining a display signal, outputting the display signal to the driver, recording vehicle dynamics signals during a parking maneuver, evaluating the parking maneuver based on the recorded vehicle dynamics signals and outputting an evaluation signal, as well as changing the at least one limiting value as a function of the evaluation signal and the display signal. In this way, an adaptive parking space measuring is made possible in which an evaluation of the parking space length is automatically adapted to the particular driving behavior and driving capability of the particular driver, whereby a high acceptance of the parking space measuring system by the driver is achieved in particular.

### SUMMARY

The example procedure according to the present invention may have the advantage that a parking maneuver of a vehicle is stored and/or evaluated by a control unit based on at least one sensor signal, and an assistance for the parking maneuver may be ascertained in the form of optimization tips based on the stored sensor signals. Here, the optimization tips are not ascertained directly during the parking maneuver and communicated to the user acoustically and/or visually, but on a computer, which is separate from the control unit of the vehicle, after the data transmission is completed. The sensor signals stored during the parking maneuver are evaluated in a setpoint-actual comparison and the results are displayed to the user in text form and/or graphically.

After at least one parking maneuver, the user may analyze it and request optimization tips to be output based on various criteria. This has the advantage over the related art that the user may take the time to carry out the analysis, i.e., without having to pay attention to the traffic, for example, and without a safety hazard resulting from the parking situation.

The user may advantageously improve his/her parking behavior based on the optimization tips and, resulting therefrom, may implement a lower fuel consumption or tire wear, as well as reduced parking time and/or a smaller effect on and endangerment of the remaining traffic.

The improvement of the parking behavior makes the user feel more comfortable during parking maneuvers; in this way, the user is able to use the optimized parking behavior even in vehicles without the system according to the present invention.

Another advantage arises due to the possibility of storing and analyzing the accumulated stored sensor signals from different parking maneuvers. This information may be used to draw conclusions on the degree of optimization, for example, and/or to identify further potential with regard to lesser material usage.

Another advantage of storing the sensor signals during the parking maneuver may be seen in that they may be stored and/or evaluated individually for each user. For this purpose, it is possible that different memories are used for individual users to be able to assign the particular parking maneuvers. An automatic recognition of the user based on different sensor signals in the control unit, such as seat position, the steering wheel position, weight and/or driving style of the user, is also conceivable. It is also possible that the user manually selects the present user, for example, by entering an identification number and/or by selecting a possible entry in a list, which is made available to the user, potentially combined with a personal secret code. It is also possible to differentiate the users based on their vehicle keys which, for example, identify the user with the aid of different codes.

All named possibilities of identifying the present user may, for example, be carried out when the vehicle is being unlocked, after and/or during a new start of the vehicle, during the instantaneous driving cycle and/or during a particular parking maneuver.

Further advantageous specific embodiments of the present invention are the subject matter of the subclaims.

Thus, ultrasound, radar, and/or infrared sensors, capacitive sensors, LIDAR sensors (light detection and ranging), and/or surroundings cameras may be used to detect the at least one sensor signal. The at least one sensor signal may preferably be a steering angle signal and/or a wheel pulse counter signal. Different implementations are possible as a function of the sensors used; if sensors having a higher measuring accuracy are used, for example, the parking maneuver may be further optimized.

The data transmission from the control unit to a computer, which is separate from the control unit, may take place with the aid of an interface, e.g., a USB connection and/or a wireless connection module. The data transmission may advantageously take place manually and/or in an automated manner. The use of the USB connection and/or the wireless connection module enables comfortable, user-friendly and/or fast data transmission.

The control unit and/or a computer, which is separate from the control unit, preferably contain(s) at least one electric memory in which the method steps are stored as a computer program.

The example computer program according to the present invention provides that all steps of the method according to the present invention are carried out when it is run in a control unit and/or on a computer, which is separate from the control unit.

The example computer program product according to the present invention having program code stored on a machine-readable medium executes the method according to the present invention when the program is run in a control unit and/or on a computer, which is separate from the control unit.

### BRIEF DESCRIPTION OF THE DRAWINGS

Exemplary embodiments of the present invention are illustrated in the figures and explained in greater detail below.

FIG. 1 shows a parking situation which is relevant for the method according to the present invention.

FIG. 2 shows a flow chart of a specific embodiment of the method according to the present invention.

FIG. 3 shows a specific embodiment of a device suitable to carry out the method according to the present invention.

### DETAILED DESCRIPTION OF EXAMPLE EMBODIMENTS

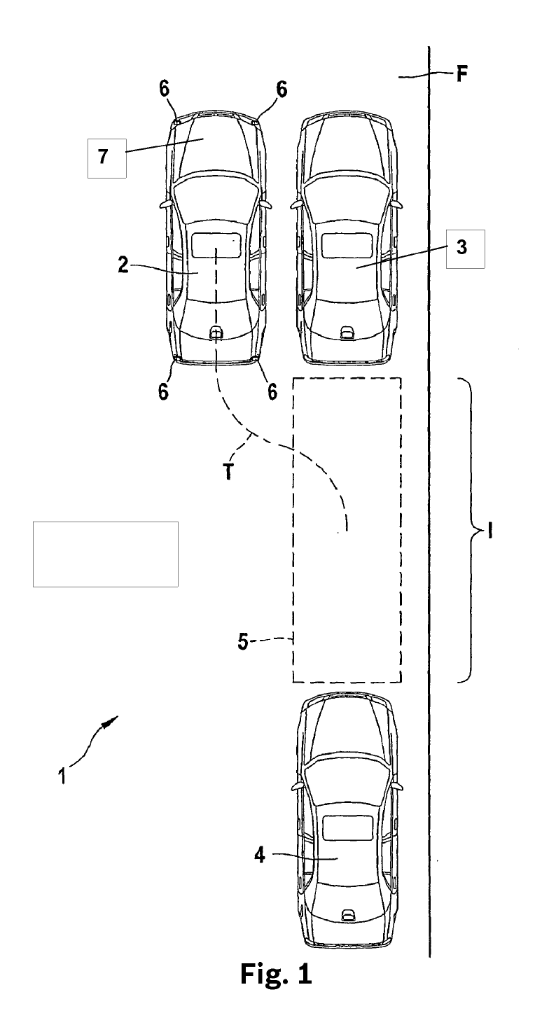

Road situation 1 illustrated in FIG. 1 shows a standing vehicle 2, a parking space 5, which is located between two parked vehicles 3 and 4 on a roadway F, and a certain length I, as well as a trajectory T implemented by vehicle 2 during the parking maneuver. Standing vehicle 2 has at least one sensor 6 and/or 7. Ultrasound, radar, and/or infrared sensors, capacitive sensors, LIDAR sensors (light detection and ranging), and/or surroundings cameras may be used as sensor 6, for example. Sensor 7 may, for example, detect a steering angle signal and/or a wheel pulse counter signal.

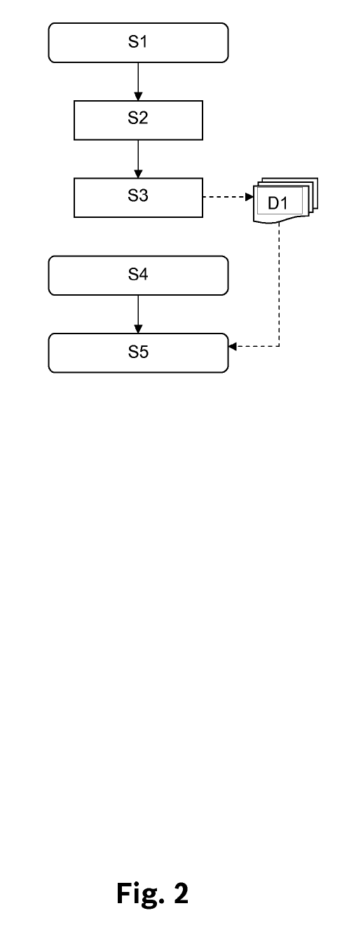

FIG. 2 shows a flow chart of the example method according to the present invention. In step S1, a method for parking space measuring is started. In step S2, characteristics of parking space 5 are ascertained with the aid of at least one sensor signal, and/or sensor signals of vehicle 2 are detected. One possible characteristic of parking space 5 may, for example, be length I and the sensor signal may be a steering angle signal and/or a wheel pulse counter signal.

In step S3, the detected sensor signals are stored for further processing in a memory Dl. In a subsequent step S4, the stored sensor signals are transmitted to a computer, which is separate from the control unit. In step S5, at least one possible scenario of a parking maneuver and of a parking surroundings is prepared based on the stored data.

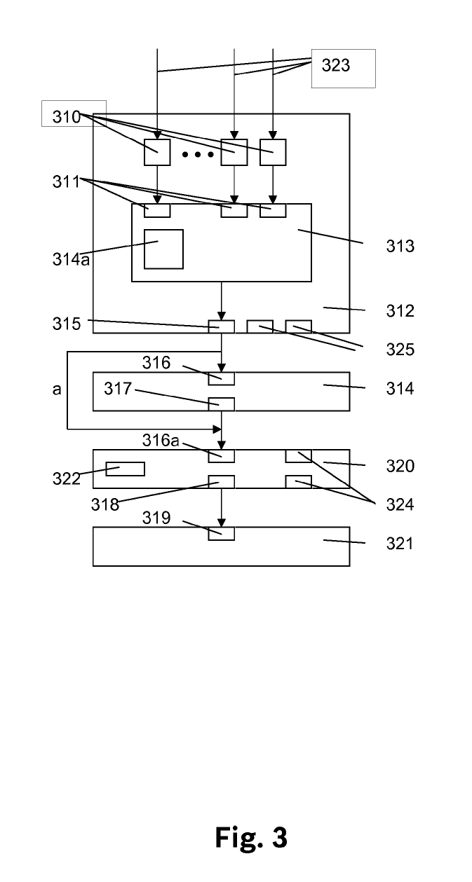

FIG. 3 shows a technical background of the example method according to the present invention. In a vehicle 312, at least one sensor signal 323 is detected by at least one sensor 310 and is made available to a control unit 313 via at least one interface 311. The signals may be transmitted to control unit 313 directly via interface 311 or, alternatively, via a bus system, e.g., a CAN bus. Control unit 313 includes at least one memory 314a for storing the sensor signals and at least one interface 315, 325.

The sensor signals may either be stored directly in memory 314a present in the control unit or via interface 315 present in control unit 313, for example, via a wired connection such as via a USB interface (universal serial bus) and/or via a wireless connection such as Bluetooth and/or WLAN (wireless LAN). With the aid of interfaces 315 present in control unit 313 and an interface 316a, the stored sensor signals may be transmitted directly to a computer 320, which is separate from control unit 313, having a memory 322. Alternatively and/or in conjunction with the direct data transmission, a memory device 314 may also be connected to control unit 313, for example, via control unit interface 315 and a memory device interface 316, and the stored sensor signals may be transmitted to memory device 314 or the stored sensor signals may be stored directly on memory means 314. An appropriate memory device may be, for example, a USB stick, a flash memory, a PDA, a smart phone, etc. Subsequently, the stored sensor signals may be transmitted with the aid of interface 316a from memory device 314 to computer 320, which is separate from the control unit, having memory 322 via another memory device interface 317.

The data transmission may take place automatically and/or manually between control unit 313 and computer 320, which is separate from control unit 313, or memory device 314.

The stored sensor signals may subsequently be used for a parking assistance method or a ParkPilot method to ascertain a setpoint-actual comparison between a trajectory T of vehicle 2 which was implemented during the parking maneuver into parking space 5 and an optimized trajectory calculated on the basis of the stored sensor signal.

The setpoint-actual comparison is carried out on computer 320, which is separate from control unit 313, based on the at least one sensor signal. For this purpose, a scenario of the parking maneuver and the parking surroundings is demonstrated based on the stored sensor signal.

Trajectory T actually followed during the parking maneuver is used here as an actual trajectory. The parking surroundings demonstrated based on the stored sensor signal are used as the basis for setpoint trajectory calculations. The setpoint trajectory represents an optimized trajectory; here, criteria such as a shortest possible parking path, smallest amount of steering wheel movements and/or a fastest possible parking maneuver are possible for an optimization.

The setpoint-actual comparison may provide tips for optimizing the parking maneuver. For this purpose, the result of the setpoint-actual comparison is displayed via interfaces 318, 319 in text form and/or graphically. For example, a graphic display 321 is possible of the differences between the actual trajectory followed during the parking maneuver and the calculated optimized trajectory as well as tips in text form and/or graphically highlighted about what change at what point in time of the parking maneuver would have improved and optimized the parking maneuver. Here, it is possible that the user is able to choose between the different criteria and the particular optimization tips are indicated to him.

The optimization tips may result in achieving a lower fuel consumption or tire wear, as well as reduced parking time and/or a smaller effect on and endangerment of the remaining traffic.

The setpoint-actual comparison may be carried out not only based on the stored sensor signals but also as a setpoint-actual comparison based on accumulated stored sensor signals from multiple data transmissions, optionally recorded at different points in time.

The method is not only suitable for parking maneuvers carried out in illustrated road situation 1, but also for other road situations such as in the case of parking spaces at right angles to the roadway.

The setpoint-actual comparison on computer 320, which is separate from control unit 312, may be carried out with the aid of software which may be transmitted to computer 320 for this purpose with the aid of at least one interface 324. Computer 320 may be any computer having at least one appropriate computing power for the calculation and/or the display capability of the setpoint-actual comparison such as a PC, a notebook, a netbook, a smart phone, etc.

1-10. (canceled)

11. A method for assisting a parking maneuver of a vehicle, comprising:
evaluating and storing at least one sensor signal by a control unit during the parking maneuver; and
carrying out, based on the stored sensor signal, setpoint-actual comparison between a trajectory followed by the vehicle during the parking maneuver and an optimized trajectory calculated based on the stored sensor.

12. The method as recited in claim 11, wherein the stored sensor signal represents a distance to at least one object which at least one of delimits a parking space and is located in the trajectory used for parking

13. The method as recited in claim 11, wherein the sensor signal is at least one of a steering angle signal and a wheel pulse counter signal.

14. The method as recited in claim 12, further comprising:
detecting the distance to the at least one object using at least one of ultrasound, radar, infrared sensors, capacitive sensors, LIDAR sensors, and surroundings cameras.

15. The method as recited in claim 11, wherein the stored sensor signals are transmitted to a PC, which is separate from the control unit, with the aid of an interface in the control unit.

16. The method as recited in claim 15, wherein the interface is at least one of a USB connection and a wireless connection module, and the transmission takes place at least one of manually and in an automated manner with the aid of a computer which is separate from the control unit.

17. The method as recited in claim 15, wherein the setpoint-actual comparison is carried out on the computer, which is separate from the control unit, based on the at least one stored sensor signal.

18. The method as recited in claim 17, wherein a result of the carried-out setpoint-actual comparison displays differences between the trajectory followed by the vehicle during the parking maneuver and an optimized trajectory calculated on the basis of the stored sensor signal at least one of in text form, and graphically, and provides tips for optimization.

19. A memory device computer program storing program code for assisting a parking maneuver of a vehicle, the program code, when executed by a computer, causing the computer to perform the steps of evaluating and storing at least one sensor signal by a control unit during the parking maneuver, and carrying out, based on the stored sensor signal, a setpoint-actual comparison between a trajectory followed by the vehicle during the parking maneuver and an optimized trajectory calculated based on the stored sensor signal.

20. A computer-readable data medium storing a computer program having program code for assisting a parking maneuver of a vehicle, the program code, when executed by a computer, causing the computer to perform the steps of evaluating and storing at least one sensor signal a control unit during the parking maneuver, and carrying out, based on the stored sensor signal, a setpoint-actual comparison between a trajectory followed by the vehicle during the parking maneuver and an optimized trajectory calculated based on the stored sensor signal.
